(19) United States
(12) Patent Application Publication
(10) Pub. No.: US 2007/0061411 A1
(43) Pub. Date: Mar. 15, 2007

(54) System and method for adaptive publishing using one or more distribution nodes in an optionally shared publishing network

(76) Inventors: John J. Laughlin, Houston, TX (US); John F. Mewshaw, Roswell, GA (US)

Correspondence Address: Hugh R. Kress;Browning Bushman P.C., Suite 1800, 5718 Westheimer, Houston, TX, 77057, US

(21) Appl. No.: 11/384,658

(22) Filed: Mar. 20, 2006

Related U.S. Application Data
(63) Continuation-in-part of application No. 10/943,722, filed on Sep. 17, 2004.
(60) Provisional application No. 60/663,328, filed on Mar. 18, 2005.

(51) Int. Cl. G06F 15/16

(52) U.S. Cl. 709/217

(57) ABSTRACT

The present invention relates generally to a system and method for publishing and distributing briefings, information, articles, advertisements, data, and the like to specific consumers in industries such as travel, health care, and retail, and more particularly, to a publishing system that shares, among publishers and advertisers, both content resources and information about the intended recipient's interests, location, and thereby providing publishers and advertisers a method to adapt the contents of a publication or electronic medium to the interests, demographics, and current circumstances of each recipient.

### RELATED APPLICATION DATA

This application claims the priority of prior U.S. provisional application Ser. No. 60/663,328 filed on Mar. 18, 2005. The provisional application is hereby incorporated by reference herein in its entirety. This application further claims the priority of and is to be considered a continuation-in-part of prior U.S. patent application Ser. No. 10,943,722, entitled “Method and Apparatus for Facilitating Information, Security, and Transaction Exchange in Aviation,” filed on Sep. 17, 2004, which application is also hereby incorporated by reference herein in its entirety.

### FIELD OF THE INVENTION

The present invention relates generally to a system and method for publishing and distributing briefings, information, articles, advertisements, data, and the like to specific consumers in industries such as travel, health care, and retail, and more particularly, to a publishing system that shares, among publishers and advertisers, both content resources and information about the intended recipient's interests, thereby providing publishers and advertisers a method to adapt the contents of a publication or electronic medium to the preferences, interests, and current circumstances of each consumer.

### BACKGROUND OF THE INVENTION

Patients in a healthcare provider's office, travelers in an airplane, anyone waiting for a car to be repaired, and many other persons in varying situations have one thing in common, namely that they pass time reading magazines but find themselves sorting through dated publications they have already read or have no interest in reading. Businesses that provide their customers these limited reading choices are foregoing an opportunity to offer such captive audiences a system that offers readers the exact content they wish to read combined with advertising and other information the business chooses to direct toward their customer.

Aircraft operators (ACOPs), for example, lack a system by which they can offer the traveler personalized information tailored to include trip specific items such as arrival/departure times, weather forecasts, catering menu, ground transportation arrangements, lodging information, maps, points of interest, business documents, news, articles, advertising, and private messages/reports that can be combined into a customized briefing for each flight.

Transportation providers, such as Fixed Base Operators (FBOs), aircraft operators, rental car companies, hotels, and limousine firms need methods to differentiate their offering from competitors. Distributing information to executive travelers offers FBOs and other service providers a means to build brand loyalty and enhance the relationship with their traveler/customer.

Health care providers lack a method to offer waiting patients reading material focusing on their individual health issues and articles of interest tailored to the preferences of the recipient. As in other businesses, health care providers search for a means to enhance the relationship with their customers.

Suppliers of goods and services continue to search for methods to more accurately focus advertisements to specific buyers.

These and other deficiencies in the prior art are addressed by the present invention, although the invention should not be construed as limited to a system that addresses all of the deficiencies simultaneously.

### SUMMARY OF THE INVENTION

In view of the foregoing considerations, there is believed to be a need for a computerized method for publishing and distributing briefings, information, articles, advertisements, and data by adapting the contents of the publication or electronic medium to the preferences, interests, and current circumstances of each intended recipient while optionally sharing among participating publishers and advertisers, both content resources and information about the intended recipient's interests and demographics. More specifically, there are needs:

to provide businesses a means to direct specific, personalized, timely information to their customers and in so doing, add value to what that business offers;

to provide businesses a means to pool resources, providing articles that correspond to the customer's area of interest without duplicating what their customers read;

to provide travel providers a means to communicate key information to their passengers about itineraries and arrangements such as catering fare and ground arrangements;

to provide health care providers a means to educate their patients on topics addressing health issues pertinent to each individual;

to provide distributors not acting in the role of publisher, a means to build brand loyalty by providing publishers and their customers (recipients) the service of printing and distributing the publication item;

to provide readers a means to provide their own reading material while flying or participating in any other situation that involves waiting or idle time;

to provide advertisers a hype-accurate means to focus and tailor advertisements to specific individuals with nearly instantaneous statistics on circulation on an ad by ad basis.

The foregoing objects and advantages of the invention are illustrative of those which can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variations which may be apparent to those skilled in the art. Accordingly, the present invention resides in the novel methods, arrangements, combinations, and improvements herein shown and described.

In a preferred embodiment, the invention utilizes and enhances the network-described in U.S. patent application Ser. No. 10/943,722 “Method and Apparatus for Facilitating Information, Security and Transaction Exchange in Aviation” filed in the name of John J. Laughlin et al. (the '722 application), which is hereby incorporated by reference herein in its entirety.

In one embodiment, the present invention is a service chain network coupled to a plurality of gateway terminals used by aircraft operators (ACOPs), 3^{rd} party Pax, and governmental agencies such as NORAD, FM, and TSA. The service chain is also populated by various suppliers of products and services. All service chain members, hereinafter portals or chain portals, participating on the system, are licensees of the software and hardware necessary to create and operate a portal. Portals are classified by types. Each portal classification is served by a unique set of software and hardware tools necessary to operate its portal type. All portal users are also licensees of the software and hardware necessary to operate a portal, and therefore are “trusted” users of the system. A gateway terminal is one or more computers and peripheral devices used by ACOPs and government agencies. All gateway users are also licensees of the software and hardware necessary to operate a gateway, and therefore, “trusted” users of the system. Certain gateways and portals are designated as Publishers on the system allowing them to control the infolet's layout and determine who receives the publication. Gateways and portals designated as Distributors are responsible for printing or transmitting each publication. Contributors of articles and documents, referred to as 3^{rd} Party PAXS; serve as a gateway provided they know the recipient's master ID number.

In one embodiment, the present invention uses passenger manifests to publish a combination executive briefing and in-flight magazine, referred to as an “infolet,” that includes contents tailored to the passenger's individual preferences.

Operators of corporate jets, as part of the process of scheduling aircraft flights, load a list of passengers and crew members into a flight manifest. The present invention maintains and manages the preferences of each of these travelers, also referred to as recipients. For example, passenger John Doe may be interested in golf, boating, tax free municipal bonds, commodities, and collecting wine. Mr. Doe's personal information and relationship with the aircraft operator, e.g., customer, client, guest, V.P. Sales, lead passenger, crew member, etc. is also stored along with identification data such as the last five digits of credit card number(s) or drivers license information. A unique system wide master identification number is then assigned to each individual's record.

Once a specific trip leg is scheduled, the system initiates a procedure that creates an infolet for each individual traveler included in the manifest. Each aircraft operator, acting as Publisher, determines the size and layout of the infolet. For example, the aircraft operator may elect to lead with a cover page containing the passenger's name, and trip details such as aircraft type, aircraft safety information, arrival/departure times, crew names, etc. This could be followed by sections for destination information, such as hotel and ground transportation arrangements, points of interest, maps, and a concierge briefing on the city or area to be visited. Next, the infolet might contain any business documents/messages entered into the system by the traveler's secretary. The traveler, in fact anyone associated with the traveler, can forward articles and documents using electronic mail to a private article inventory for inclusion in the in-flight document. The traveler's spouse might scan in a drawing made that day at school by his/her child. The operator might then designate the next section(s) be selected from an inventory of articles in which the traveler has an interest. The traveler can also access the system web-site and select specific articles for inclusion. Finally, the Publisher might add a survey to the infolet.

Intermixed throughout the infolet are advertisements from 3^{rd} party advertisers, the FBOs on both ends of the flight, and the aircraft operator. Advertisers can tailor ads based on the interest profile and demographics for each traveler, then ascertain the exact number of distributed advertisements. Advertising fees can then be based on actual audience statistics.

For children, the system generates age appropriate content such as coloring material and games similar to that provided by restaurants. The system can allow older children to designate age appropriate preferences and content.

It is important to note the invention supports an information sharing capability for each traveler provided the publisher authorizes sharing. The system also allows users to draw from a pool of articles and other resources such as maps, weather reports, and concierge information. Articles are tracked by the system as they are distributed to each recipient so that no other publisher will repeat the publication of that article to the individual. Publishers may also maintain a proprietary inventory of articles, with restricted or prohibited sharing.

Just prior to the flight's departure, the FBO or departure facility node, acting as Distributor, is granted electronic authority by the Publisher to print and distribute infolets to the individual passengers/crew members. Infolets designated as containing sensitive information must be accessed by swiping a credit card or driver's license through an attached card reader or by entering an access code provided by the publisher to the recipient who may then receive the document at the distribution point kiosk.

This process of publishing and distributing is repeated at each stop on the aircraft's trip; provided, of course, the publisher has authorized an infolet and the “stop” has distribution capabilities.

In accordance with another aspect of the invention, the system accesses hotel reservation records to create an “in-room” infolet for guests. Hotel operators participate in the system as both publisher and distributor nodes by including the guest's master ID in the reservation information. The hotel distributes the documents by “publishing” an infolet for each guest for which a master ID resides in the reservation record. The system prevents infolet distribution unless the master ID contains the driver's license number or credit card number used when checking in.

Variations in distribution media are also possible. In accordance with another aspect of the invention, rental car companies participate on the system in a manner similar to a hotel reservation. These firms function as both publisher and distributor, but instead of a printed document, the system uses recordings and text-to-speech technology to convert printed text to an oral presentation burned to a CD and provided to the traveler for playback via the car's CD player. Such a presentation could include a welcome message, safety information about the car, and of course articles, advertisements, entertainment vignettes, and information about local points of interest and dining out.

Other distribution variations include internet or wireless downloads of the infolet to aircraft mounted display processors, e.g., tablet PC's, to the traveler's laptop, or to the traveler's cell phone or mp3 player.

In accordance with another aspect of the invention, health care providers can act as both publisher and distributor nodes for waiting patients. Physicians can direct articles on health issues that apply to the reader/patient drawn from the physician's inventory or the system's inventory of articles and advertisements. The health care provider (publisher) can also provide the reader with personal data such as a graph of his/her blood pressure and weight plotted over time.

The following section sets forth further details and examples of one embodiment of the invention. This section is designed to illustrate a publishing system designed to communicate information directed toward specific consumers, patients, or travelers, by tailoring the content of each publication to the preferences, interests, and current circumstances of the intended recipient, and thereafter tracking all content provided to the recipient by the various publishers and advertisers participating on a secure, private network that facilitates information sharing and publication distribution.

Industry names are used for illustrative purposes but are not intended to imply a business relationship exists between these entities and the inventors.

The aforementioned U.S. patent application Ser. No. 10/943,722 (the '722 application) provides a system and method of transacting business and exchanging and displaying information between general aviation participants such as aircraft owner/operators, pilots, departure facilities, fuel suppliers, credit providers, third-party suppliers, the Transportation Security Administration (TSA), NORAD, and the Federal Aviation Administration (FAA).

### BRIEF DESCRIPTION OF THE DRAWINGS

The foregoing and other features and advantages of the invention will be best appreciated with referenced to a detailed description of specific embodiments thereof, when read in conjunction with the accompanying drawings, wherein:

FIG. 1 is a block diagram of a computer-based platform for facilitating information, security and transaction exchange in aviation in accordance with one embodiment of the invention;

FIG. 2 is a block diagram of an adaptive publishing system's architecture and data flow in accordance with the presently preferred embodiment of the invention.

FIG. 3 is a block diagram of a sample printed version of an infolet in accordance with one embodiment of the invention.

### DETAILED DESCRIPTION OF A SPECIFIC EMBODIMENT OF THE INVENTION

In the disclosure that follows, in the interest of clarity, not all features of actual implementations are described. It will of course be appreciated that in the development of any such actual implementation, as in any such project, numerous engineering and programming decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

Furthermore, for the purposes of the present disclosure, the terms “comprise” and “comprising” shall be interpreted in an inclusive, non-limiting sense, recognizing that an element or method step said to “comprise” one or more specific components may include additional components.

### System Description

Overall System

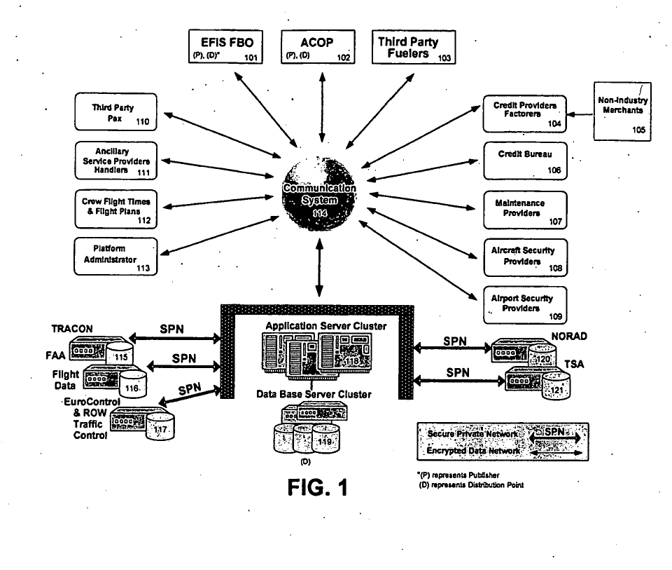

Referring to FIG. 1, there is shown a block diagram of an integrated platform 10 for facilitating an information, security and transaction exchange in the general aviation industry in accordance with one embodiment of the invention. As shown in FIG. 1, central to platform 10 is an application server cluster 118 and associated database server cluster 119 which serves as a central host/manager for transactions carried out on the platform and for information exchange between various participants and modules in the system.

Application server cluster 119 also is linked to a communications system 114 via, in one embodiment, a high-speed communication link. Communication system 114 embodies any and all means of communication between participants and modules in platform 10, including, without limitation, satellite links, the Internet, and telephonic connections.

As can be observed in FIG. 1, communications system 114 serves to provide a communications link between various gateways and portals in platform 10 and application server 118. In particular, communications system 114 links an EFIS FBO portal 101, and ACOP gateway 102, a third-party fuelers portal 103, and a third-party PAX portal 110 to the application server 118. Additionally, other platform participants are linked to application server 118, including an ancillary service provider portal 111, a crew flight times and flight plans portal 112, credit provider portal 104, a credit bureau portal 106, a maintenance provider portal 107, an aircraft security provider portal 108, an airport security provider portal 109, and a platform administrator portal 113. The platform administrator portal 113 enables the operator of application server 118 to oversee operation of platform 10.

EFIS FBO Portal

Various components of platform 10 are depicted in FIG. 1. The primary portal type is the EFIS FBO portal 101. Each FBO portal 101 (and it is contemplated that a platform 101 will include a large number thereof) receives software and hardware designed to manage workflow, marketing, sales, inventory, pricing, and security in a unique way. The FBO portal is one of the key components of the present invention and is referred to as an Electronic FBO Information System, hereinafter “EFIS.”

In accordance with one aspect of the invention, EFIS FBO portal 101 is a supplier portal to enable FBO participants to integrate customer service requests into a combined workflow using task queues, to allow FBOs to market directly to their customers at the exact moment that the customers are making travel decisions. The EFIS FBO portal 101 further facilitates the dissemination of complex private and public pricing structures to both retail and wholesale purchasers.

Platform 10 allows suppliers to “broadcast” prices and information to consumers in real time. The supplier can tailor these prices to the consumer, based on information about the consumer's operating and purchasing patterns provided by the data maintained on application server 118. The system displays this information on computer, cell phone, wireless PDA or other emerging technologies related to input/output devices.

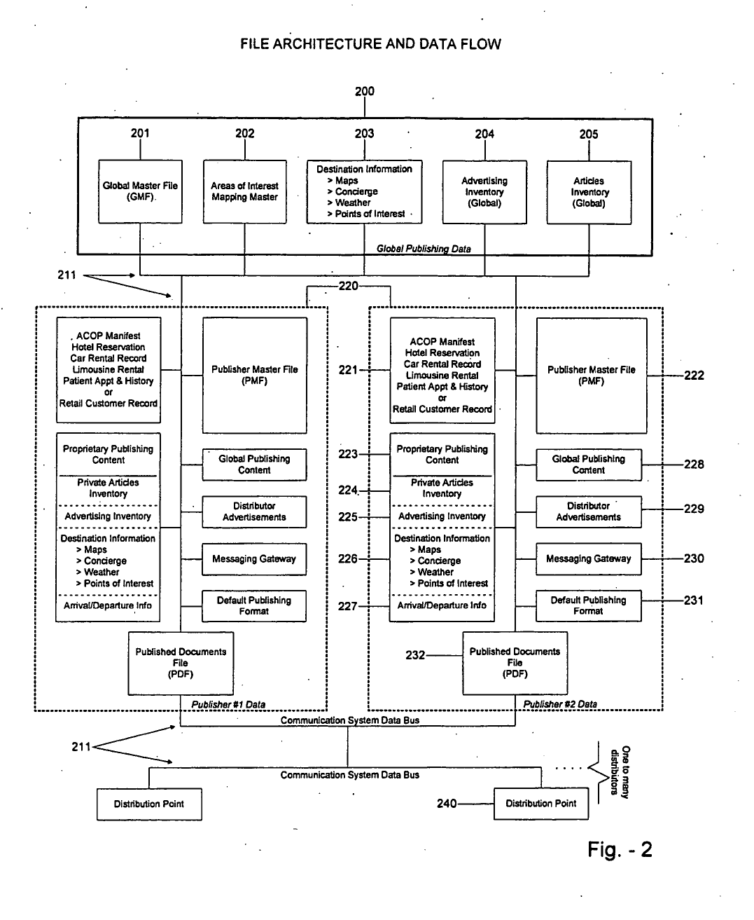

Referring to FIG. 2, block diagram 200 depicts data available to the entire system (all publishers). The attendant files are contained in the server cluster of Platform 10; transmitting and receiving data via communication system 114.

Files contained with block 200 include the GlobalGlobal Master File (GMF) 201 containing the member (recipient) names, including identification data and preferences.

Block 200 also includes Areas of Interest file 202, containing a master listing of member interests such as wine collecting, travel, astronomy, finance, knitting, etc., destination information file 203 containing information specific to any destination. For example, destination Atlanta, Ga., USA would contain points of interest, maps, weather information location code, and concierge information such as restaurants, hotels, and anything a member's preferences might indicate a need to locate such as sports venues, museums, etc.

With continued reference to Block 200, Advertising Inventory file 204 contains detailed information on advertisers, the location of each advertiser's product or service, and a advertisement generator tailored to each specific member and publisher. A more detailed discussion of Advertising 204 is set forth in the above-referenced U.S. patent applications incorporated by reference herein.

Block 200 also includes Articles Inventory file 205 which contains an inventory of articles, white papers, magazines, etc., corresponding to members areas of interest. Frequency of use data is maintained on article popularity. A more detailed discussion of Advertising 205 is set forth in the above-referenced U.S. patent applications incorporated by reference herein.

Block 200 files communicate with other system files via communication system data bus 211.

Turning to Blocks 220, this collection of files represent data specific to one to many publishers. A publisher is defined as an aircraft operator, hotel, ground transportation provider, caterer, physician, retail outlet, etc., that have one or more members to whom they wish to disseminate information.

Files 220, stored for each publisher on the server, include reservation or manifest records 221. Many airline and corporate flights contain a manifest of passengers onboard each trip leg. Car rental offices or physicians maintain reservations. In the instance of transportation, information regarding origin and destination are included. Each reservation or manifest contains the member's identification code, if known.

This information is compared to the Publisher's Master File (PMF) 222 containing the members known to the Publisher. If the member is unknown, the system searchs the GMF for a match and copies the record into the PMF. If neither the GMF or PMF files match the manifest or reservation, a new member record is created and identification data is requested.

Publishing Content file 223 serves as a link or storage for private articles 224 available for publishing. These represent each member's personal inventory of articles and the publisher's proprietary articles he wishes to include in a member's personalized Infolet. Advertisements 225 contains ads that are available for publishing in each member's Infolet. It is important to note that each advertisement is nano targeted to each member's demographics, destination. The system also generates specific advertisements generated by the advertiser based on the ads provided to the member previously. This allows for the inclusion of the more lucrative advertisements generated by local merchants and allows a advertising campaign tailored to a specific member. For example, while one passenger sees the first of a series of advertisements from a high-end automobile manufacturer, another passenger who has recently purchased such a product or has other interests is seeing advertisements for something else.

Publishing Content file 223 also contains destination information 226 including appropriate maps, real-time weather information, points of interest, and concierge information such as restaurants, hotels, and anything a member's preferences might indicate a need to locate such as sports venues, museums, etc.

Arrival/Departure information 227 contains detailed information regarding the trip leg schedule, city pairs, ground transportation arrangements, pick-up/drop-off locations, etc.

Global Publishing Content 228 is a list of articles available to the member but not previously published to that member. Articles are obtained from global file 205. Note that once a member receives a specific article, regardless of publisher, the systems records that information to avoid repeating the article's publication.

Distributor advertisements 229 contains ads generated by each location's Infolet distributor and to be included in the members' Infolets.

Messages directed at each member are stored in the Messaging Gateway 230 and consistent with other objects included in the members' Infolets, contain status information that reveal the disposition of the messages.

The Infolet is prepared electronically on demand by the distributor or member according to a predetermined format contained in 231 and transferred to the distribution point 240 for printing or electronic dissemination. This technique allows for the publication to contain the most up to date information.

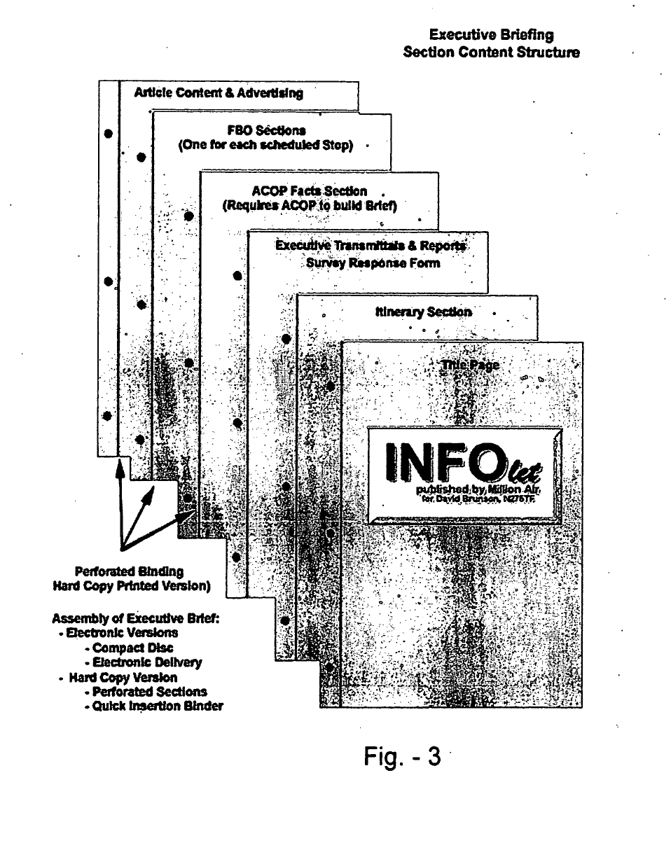

Referring to FIG. 3, a sample version of a printed Infolet is displayed.

### Graphical User Interface

In accordance with one aspect of the invention, users interact with the EFIS FBO portal 101 and ACOP gateway 102 via a graphical user interface. The following briefly describes some of the screens presented to users during normal operation of the system:

The FBO Setup window shown in FIG. 6 of the aforementioned '722 application provides the user a means to input the unique information about his FBO. The main information page includes general details such as name, address, location, phone numbers, and time zone.

From the foregoing detailed description of specific embodiments of the invention, it should be apparent that methods and apparatuses for facilitating information, security and transaction exchange in aviation have been disclosed, as well as methods and systems for adaptive publishing of information in a variety of contexts. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested in the present disclosure, may be made to the disclosed embodiments without departing from the spirit and scope of the invention as defined by the appended claims, which follow.

What is claimed is:

1. A system for on-demand publishing utilizing various mediums comprising:
an application server coupled via a network to at least one supplier of products/services;
at least one publisher, having access to said network and said application server, said at least one publisher providing content adapted for distribution to a targeted recipient.
